(19) United States
(12) Patent Application Publication
(10) Pub. No.: US 2020/0401985 A1
(43) Pub. Date: Dec. 24, 2020

(54) SYSTEM AND METHOD FOR THE ADAPTIVE SCHEDULING OF HOURLY STAFF TO OPTIMIZE LABOR COST

(71) Applicant: BRANCH MESSENGER INC., Minneapolis, MN (US)

(72) Inventors: DIVYDEEP AGARWAL, Minneapolis, MN (US); HIMANSHU MISRA, Minneapolis, MN (US)

(21) Appl. No.: 16/905,015

(22) Filed: Jun. 18, 2020

Related U.S. Application Data
(60) Provisional application No. 62/862,770, filed on Jun. 18, 2019.

(51) Int. Cl. G06Q 10/06; G06Q 10/04; G06K 9/62; G06N 3/08

(52) U.S. Cl. CPC G06Q 10/063118; G06Q 10/063116; G06N 3/086; G06K 9/6256; G06Q 10/04

(57) ABSTRACT

A system and method for the adaptive scheduling of hourly labor cost through the use of an electronic device to predict a preferred schedule of a workforce. In particular, the computer implemented method of the present disclosure allows for the input of data in the form of employees and demand and utilizes computer processing and machine learning to model a predictive schedule based upon the input data in the form of a generated schedule. By implementing machine learning in the comparison of the generated schedule and a manager generated manager schedule, the computer processing system and method steps can predict a more efficient generated schedule over time.

### CROSS-REFERENCE TO RELATED APPLICATION

This U.S. Patent Application claims priority to U.S. Provisional Application: Application No. 62/862,770 filed Jun. 18, 2019, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present disclosure relates generally to a system and method to optimize the cost of labor and time required to generate a schedule by the efficient scheduling of labor for use in retail stores, restaurants or any other such organizations which employ a dynamic/fluid (temporary) workforce.

### BACKGROUND

In a typical work environment, a schedule is generated to determine when a given employee of a workforce of employees is to work. In general, this scheduling process can be very challenging and time consuming, especially given the number of variables that may need to be considered in this scheduling process. Accordingly, several methods have been developed to create model schedules.

One such method and variants is enumerated in U.S. Pat. Nos. 8,315,901 and 8,666,795 which generally disclose a system and logic for scheduling a workforce comprised of full time workers, part time workers, and flexible workers based upon various constraints including hours worked and a multitude of staff mix enumerations between these worker types. Although these methods and logic are instructive on the need for a logic to enable the scheduling of a workforce, the method steps lack a dynamic capability that enables for dynamic scheduling and learning based upon input from a key scheduler.

An additional method for scheduling a work force is disclosed in U.S. Pat. No. 7,155,399. This '399 reference generally utilizes a computer based method to generate a task based model for ensuring the scheduled workforce is effective at completing tasks and includes features to generally simulate an impact on the scheduled workforce through the removal of an individual worker. Although this method is generally instructive on the need to schedule a workforce for the completion of a task and includes a dynamic feature to enable schedule adjustment for a given worker, it lacks sufficient to disclosure to enable learning over time and the implementation of this learning the creation and formation of additional and future schedules.

Additionally, generic methods approach workforce scheduling by employing existing methods from the fields of Operational Research and Constrained Optimizations. These methods are limited in their capacity as they do not evolve or learn from their environments after initial definitions of the models. This, as a result, demands changes in the model after every 6 months-1 year. Accordingly, this approach is not scalable and comes with additional costs to operationalize such a system.

Another set of methods traditionally used are the modern Artificial Intelligence methods like genetic programming or reinforcement learning to generate the schedules, but these methods are limited in their capacity to generate schedules in a fixed amount of time or guarantee the efficiency of the schedules. Hence, they are somewhat limited to be deployed as a production application being used at scale.

Additionally, most of these traditional methods model the information provided to them but do not account for other hidden factors like implicit manager preferences, failure in recording the data required to generate a schedule etc.

Accordingly, there is a need within the market for an improved system and method for the adaptive scheduling of hourly staff to optimize the labor costs of an employer.

### SUMMARY OF THE INVENTION

A system and method configured to solve the aforementioned challenges in the form of a hybrid approach, wherein the best features from both the traditional methods and improved methods are utilized to provide a production grade efficient scheduling solution. This algorithm-based solution, which can learn and adapt from the environment it is being operated in, generates schedules that require minimum intervention from managers. Accordingly, use of the system and method results in saved labor costs by scheduling the correct employee and the correct times for the employee to work. As the system learns from its environment (over a period of the time) it automatically encodes the hidden manager preferences and uses that information to generate more efficient future schedules. Further, the system and method steps are configured to operate even if some required information is not present, making it fault tolerant in such cases.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWING(S)

FIG. 1 is a modified wire frame diagram of the system and method, according to the present disclosure.

### DETAILED DESCRIPTION OF THE INVENTION

The following detailed description includes references to the accompanying tables and figures, which form a part of the detailed description. The tables and figures show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The system and method of the present disclosure is most generally configured for the adaptive scheduling of hourly staff to optimize labor cost through the use of execution of the method steps on hardware in the form of a plurality of computing devices to provide a resultant schedule based upon data entry, machine learning, and modeled data.

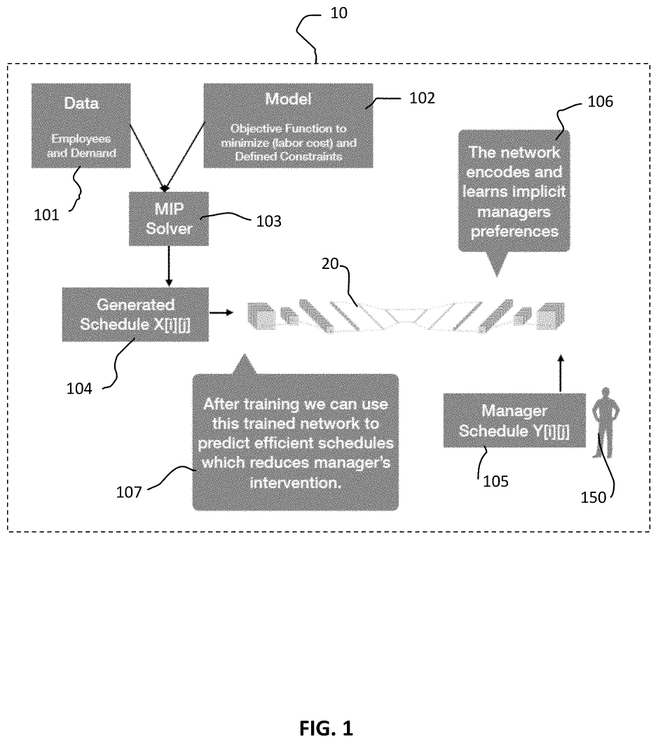

Referring specifically now to FIG. 1 and TABLE 1 of the system and method of the present disclosure, generally in the form of a computing system and method steps for the adaptive scheduling of hourly staff to optimize labor costs.

A traditional mixed integer programing (“MIP”) model for workforce scheduling can be represented in a mathematical formula with a 2-d Matrix as is shown in TABLE 1. This traditional mixed integer programming model takes in the defined model and data as an input and generates an optimized solution which meets all the constraints and minimizes the labor cost.

```
TABLE 1
A schedule can be represented as a 2-d Matrix -
  X[i][j] which takes in values {0, 1}, and where i = employee, j = hour/
  shift
The mixed integer programming solver find optimal assignment of 0 and
1s for X which minimizes the labor cost and satisfy a set of constraints
defined at the time of model creation. For example we can say that an
employee i can not be assigned to more than 40 hours of a shift in a week,
$which can be translated to {\sum }_{j} x [ i ] [ j ] < = 40 ∀ j$
```

Although this traditional schedule as shown in TABLE 1 is helpful, it can only generate a schedule that meets the defined constraint. Accordingly, defining all of the constraints manually is not scalable, wherein a typical workplace MIP may have close to 200 constraints. This number of constraints may result in a management nightmare and generate unwanted results or an unsolvable model, due to conflicting constraints. Further, the fixed nature of the MIP model cannot adapt over time and by learning from user interactions with the MIP generated schedules.

Referring now to FIG. 1, the system and method of the present disclosure generally referred to as system and method 10 utilizes the traditional MIP model generated schedule, as shown in TABLE 1, to generate an improved schedule by capturing manager interaction through a manager schedule 105 in response to a generated schedule 104, wherein the system and method 10 is most generally utilized to track how a given manager 150 changes and edits the generated schedule 104 for plurality of employees and designated hours/shifts for a given scheduling period. The system and method 10 is generally configured in the form of logic configured for placement onto a server 20 and hosted for access by a client user, such as the manager 150, wherein this user 150 will interact with the system and method 10 through inputs, review, and learning 106, 107 to improve the generated schedule 104 over time with continual manager 150 interaction. The server 20 functioning a repository for the logic and may be a cloud-based computing system hosted at a remote location or alternately placed onto a local computing machine or distributed between local and remote resources. Still further, this server 20 may be present as a feature on an application accessible through a personal electronic device or the like to enable easy access to the manager 150 or potentially providing in alternate forms accessible to workers for viewing without editing or input capabilities.

Accordingly, an exemplary situation utilizing the system and method 10 of the present disclosure can be used to illustrate how a given schedule is created. For example, based upon user data 101 for a given workforce logic is utilized to solve the MIP 103 for the objective function model 102, wherein an MIP output is X[i][j] for a given workforce schedule identified as the generated schedule 104. The manager 150 will then view the output X[i][j], in the form of the generated schedule 104 and make modifications creating a new schedule Y[i][j] and identified as the manager schedule 105. A neural network (“NN”) is built and utilized to learn, step 106, and translate X[i][j] (104) to Y[i][j] (105) through a 2d convert with network architecture as an Auto-encoder over time.

Through continued use and interaction by the manager 150 through schedule alterations 105, the NN can be optimized and efficiency quantified by how accurately the NN predicts the manager generated schedule Y[i][j] (105) from X[i][j] (104). Therefore, the NN allows for the encoding of hidden manager 150 preferences as weights of the network 106 and learns and adapts 107 over a period of time as the manager 150 generates more and more Y[i][j] (105). Further, the NN can be trained using stochastic gradient descent or an evolutionary algorithm to find the optimum set of weights and predict a more accurate schedule 104 requiring less and less manager 150 interactions.

The system and method 10 of the present disclosure makes use of deep learning algorithms to adapt to the environment its being operated in (retail stores/restaurants etc.). As this system 10 is heavily reliant on huge amounts of data to provide any improved results, which can lead to a lag time of 6-8 months of data collection phase for new clients before the discovery of additional gains, the system utilizes recent advances in “Zero Shot Learning” and “Few Shots Learning” and incorporates those methods into the learning 106 algorithm to learn manager preferences with a small amount of data.

Further to improve functionality of the system and method 10 of the present disclosure, testing with data argumentation methods like GANs (“Generative Adversarial Network”) and other generative approaches may be utilized at steps 106, 107 to generate a simulated environment where algorithms can simulate the managers activity/preferences using the schedules and hence do not rely on large number of interactions from managers to learn their preferences.

Implementation of the system and method 10 of the present disclosure may additionally be in the form of a multi-threaded application as a microservice that can be added to a backend system. The system 10 uses method steps written in Python and packaged as a Docker container image that can be deployed on a container orchestration system like Kubernetes. It uses the Flask Web framework and runs on top of a Nginx Server. The application also integrates with Gurobi (for linear programming problem solving) as part of creating an optimized schedule. The application reads and writes data from/to a MySQL instance at the beginning of processing and after generating schedules. Some other libraries used by the code are gunicorn, mpmath, numpy etc.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implemented system and method for the adaptive scheduling of labor comprising:
providing input data in the form of employees and demand;
using a computer processing system to model a predictive schedule based upon the input data in the form of a generated schedule;
allowing a manager to edit the generated schedule to create a manager schedule;
using a computer processing system to compare the manager schedule to the generated schedule for use in learning future generated schedules; and
using a computer processing system to quantify the learning to predict a more efficient generated schedule.

2. The computer implemented method of claim 1, wherein the predictive schedule is generated through mixed integer programming.

3. The computer implemented method of claim 1, wherein the computer processing system is multi-threaded application as a microservice and hosted on a backend system.

4. The computer implemented method of claim 1, wherein the computer processing system is hosted on a cloud.

5. The computer implemented method of claim 1, wherein the quantified learning includes implicit manager preferences.

6. The computer implemented method of claim 1, wherein the learning is conducted on a neural network utilized to learn and translate the generated schedule to the manager schedule.

7. The computer implemented method of claim 6, wherein the neural network is trained to using stochastic gradient descent.

8. The computer implemented method of claim 6, wherein the neural network is trained using an evolutionary based algorithm.

9. A method for the adaptive scheduling of hourly labor cost, the method comprising:
providing input data in the form of employees and demand in the form of hours and shifts in a defined constraint;
using a computer processing system to model a predictive schedule based upon the input data and the defined constraints in the form of a generated schedule;
allowing a manager to edit the generated schedule to create a manager schedule;
using a computer processing system to compare the manager schedule to the generated schedule for use in future generated schedules by learning implicit manager preferences; and
using a computer processing system to quantify the learning to predict a more efficient generated schedule.

10. The method of claim 9, wherein the predictive schedule is generated through mixed integer programming.

11. The method of claim 9, wherein the computer processing system is multi-threaded application as a microservice and hosted on a backend system.

12. The method of claim 9, wherein the computer processing system is hosted on a cloud.

13. The method of claim 9, wherein the learning is conducted on a neural network utilized to learn and translate the generated schedule to the manager schedule.

14. The method of claim 13, wherein the neural network is trained to using stochastic gradient descent.

15. The method of claim 13, wherein the neural network is trained using an evolutionary based algorithm.

16. A computer implemented method for the adaptive scheduling of hourly employees to optimize cost and scheduling efficiency, the method comprising the steps of:
providing input data in the form of an employee and shift and time constraints for the employee;
using a computer processing system to model a predictive schedule based upon the input data in the form of a generated schedule;
allowing a manager to edit the generated schedule to create a manager schedule;
using a computer processing system to compare the manager schedule to the generated schedule;
using a computer processing system with a neural network to learn and translate based upon the comparison of the generated schedule and manager schedule in future generated schedules; and
using the neural network to quantify the learning to predict a more efficient generated schedule.

17. The computer implemented method of claim 16, wherein the predictive schedule is generated through mixed integer programming.

18. The computer implemented method of claim 16, wherein the computer processing system is multi-threaded application as a microservice and hosted on a backend system.

19. The computer implemented method of claim 16, wherein the computer processing system is hosted on a cloud.

20. The computer implemented method of claim 1, wherein the quantified learning includes implicit manager preferences.
